(19) United States
(12) Patent Application Publication
(10) Pub. No.: US 2007/0130072 A1
(43) Pub. Date: Jun. 7, 2007

(54) Optimizing output speed and replenishment in a photographic kiosk

(75) Inventor: David J. Oles, San Marcos, TX (US)

Correspondence Address: Matthew J. Booth & Associates, PLLC, P O BOX 50010, AUSTIN, TX, 78763-0010, US

(73) Assignee: Pixel Magic Imaging, Inc., San Marcos, TX (US)

(21) Appl. No.: 10/595,501

(22) PCT Filed: Nov. 4, 2004
(86) PCT No.: PCT/US04/36732

§ 371 Date: Jan. 29, 2007

Related U.S. Application Data
(60) Provisional application No. 60/517,261, filed on Nov. 4, 2003.

(51) Int. Cl. G06Q 99/00; H04L 9/00

(52) U.S. Cl. 705/51

(57) ABSTRACT

The present invention discloses a digital photographic kiosk 100 that optimizes the output speed and the replenishment of consumable media. The kiosk includes a plurality of output print devices 110 that use consumable media. A system controller 102 in the kiosk 100 controls the utilization of consumable media by the output print devices 110 in a manner that both optimizes the production of output from the output print devices 110 and optimizes the replenishment of the consumable media used by the output print devices 110.

### TECHNICAL FIELD

The present invention relates generally to load balanced production and more specifically it relates to a methodology to optimize output speed and replenishment for improving the economics and performance characteristics for fulfillment devices such as digital photographic kiosks.

### BACKGROUND ART

The methodology of load balanced production is well known in the arts. Typically, load balanced production methodology is used by kiosks or other systems that utilize manufacturing equipment that contains non-refillable consumables. One problem inherent in the prior art load balanced production methodology occurs when the system is deployed in a self service environment where the consumables are difficult to maintain as a result of a number of factors such as the costs of the consumables or supply logistics. Unlike a soda machine where the consumables (i.e., the soda cans) can be “topped off” by adding in new soda cans from the top, other systems such as photographic kiosks must be maintained on a timely fashion to keep the systems operational otherwise lost sales of the product will occur.

Digital photographic kiosks to service the digital photography market present a difficult problem for prior art load balanced methodologies. These types of kiosks include some type of output printing device for producing photographic prints. The output printing devices typically include photographic printers such as dye sublimation printers or ink jet printers with each type of printer having different consumable media. In a dye sublimation printer, the consumable media typically includes the dye transfer ribbons, the paper, and also ribbons or sheets for a protective overcoat laminate. Alternatively, the consumable media used by inkjet printers include the inkjet cartridges and the paper.

One issue with prior art load balanced production methodology occurs when changing the consumable media in a digital photographic kiosk before the consumable media is exhausted. Doing so increases the operating costs of the unit because not all of the consumable media is being used for the production of output such as photographs. However, not changing the consumable media before it is exhausted means that the system will always reach a state where it is not usable by a consumer such as when it is out of consumable media to produce the desired product such as photographic prints in this case. When this situation occurs, the owner of the kiosk invariably loses a sale because of the kiosk's inability to produce the printed photograph.

Another problem with the prior art load balanced methodologies occurs when a second output device is added to the system. In the case of the digital photographic kiosk, a second output device is the addition of a second printer. The prior art load balanced methodologies typically will only use the second output device or printer after the first output device or printer is exhausted of consumable media. This methodology has the advantage of allowing a maintenance visit to take place without wasting any consumable media in the first printer. Unfortunately, this methodology does not allow the kiosk to use the second output device so as to increase the overall output speed of the kiosk by alternating production of the output between the two output print devices. If the kiosk does alternate production of the output between the two output print devices or printers, then the kiosk will have the above described problems of running out of consumable media with lost production ability, or alternatively, changing the consumable media before it has been exhausted.

To aid in the understanding of the operational aspects of a digital photographic kiosk, attention is drawn to the kiosk disclosed in international patent application serial number PCT/US2004/002079 filed 27 Jan. 2004, which is incorporated by reference for all purposes into this specification. Additionally, several examples of digital photography kiosks are disclosed in design patent applications that include the following: U.S. Des. patent application Ser. No. 29/199,034, filed 2 Feb. 2004; U.S. Des. patent application Ser. No. 29/199,035, filed 2 Feb. 2004; and U.S. Des. patent application Ser. No. 29/199,053, filed 2 Feb. 2004. All of the prior design patent applications are incorporated by reference for all purposes into this specification. Finally, this application claims the benefits of the earlier filed U.S. Provisional App. Ser. No. 60/517,261 filed 4 Nov. 2003, which is incorporated by reference for all purposes into this specification.

### BEST MODE FOR CARRYING OUT THE INVENTION

The present invention discloses a digital photographic kiosk that optimizes the output speed and the replenishment of consumable media. The kiosk includes a plurality of output print devices that use consumable media. A system controller in the kiosk controls the utilization of consumable media by the output print devices in a manner that both optimizes the production of output from the output print devices and optimizes the replenishment of the consumable media used by the output print devices.

The system controller initially causes a disproportionate amount of utilization of consumable media to be produced from the second output print device compared to the first output print device. The disproportionate amount of utilization of consumable media from the second output print device continues until the amount of consumable media of the first output print device is in a first preferred ratio compared to the amount of consumable media in the second output print device.

When the first preferred ratio is achieved between the consumable media of the first output print device and the second output print device, the system controller alternates the utilization of consumable media between the first output print device and the second output print device until the second output print device exhausts its consumable media. Upon replenishment of the consumable media of the second output print device, the system controller causes a disproportionate amount of utilization of consumable media to be produced from the second output print device compared to the first output print device. The disproportionate amount of utilization of consumable media continues until the amount of consumable media of the second output print device is in a second preferred ratio compared to the amount of consumable media in the first output print device.

When the second preferred ratio is achieved between the consumable media of the second output print device and the first output print device, the system controller alternates utilization of consumable media between the second output print device and the first output print device until the first output print device exhausts its consumable media. Upon replenishment of the consumable media of the first output print device, the system controller causes a disproportionate amount of utilization of consumable media to be produced from the first output print device compared to the second output print device. The disproportionate amount of utilization of consumable media continues until the amount of consumable media of the first output print device is in the first preferred ratio compared to the amount of consumable media in the second output print device.

When the first preferred ratio is achieved between the consumable media of the first output print device and the second output print device, the system controller alternates utilization of consumable media between the first output print device and the second output print device until the second output print device exhausts its consumable media. The system controller maintains continued utilization of consumable media in the above alternating process.

One embodiment of the present invention uses a first preferred ratio that occurs when the amount of consumable media of the first output print device minus the amount of consumable media of the second output print device equals half the amount of consumable media available when the first output print device and the second output print device are both full of consumable media. Additionally, a second preferred ratio occurs when the amount of consumable media of the second output print device minus the amount of consumable media of the first output print device equals half the amount of consumable media available when the second output print device and the first output print device are both full of consumable media.

One embodiment of the present invention includes the use of dye sublimation printers as the first and second output print devices with dye transfer ribbons, paper, and a protective overcoat laminate as the consumable media. A separate embodiment of the present invention includes the use of inkjet printers as the first and second output print devices with inkjet print cartridges and paper as the consumable media.

Another embodiment of the present invention includes the first output print device comprising a first logical output print device and the second output print device comprising a second logical output print device. The first logical output print device further comprises one or more physical output print devices. And, the second logical output print device further comprises one or more physical output print devices.

### BRIEF DESCRIPTION OF DRAWINGS

To further aid in understanding the invention, the attached drawings help illustrate specific features of the invention and the following is a brief description of the attached drawings:

FIG. 1 is an illustration of an exemplary digital photographic kiosk.

FIG. 2 is a block diagram of an exemplary digital photographic kiosk.

FIG. 3 is a flowchart of one embodiment of the present invention.

### DISCLOSURE OF INVENTION

The present invention is an improved methodology of load balanced production for digital photographic kiosks that optimizes the output speed and replenishment of the non-refillable consumables. The present invention increases the output production of the kiosk while maximizing the economics of operating and maintaining the kiosk. This disclosure describes numerous specific details that include specific examples and components in order to provide a thorough understanding of the present invention. One skilled in the art will appreciate that one may practice the present invention without these specific details.

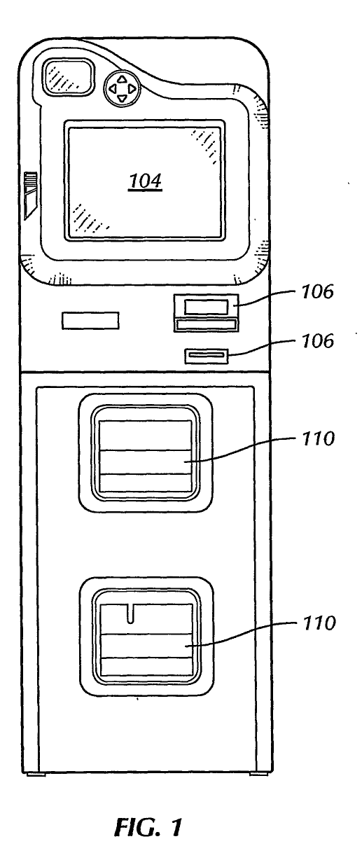

FIG. 1 is an illustration an exemplary digital photographic kiosk 100. The exemplary kiosk 100 typically comprises some type of user interface 104 that incorporates a display device. The exemplary kiosk 100 also includes the input data readers 106 that can be any device adapted to read digital data from a portable data storage device. Finally, the exemplary kiosk 100 includes one or more output print devices such as photographic printers 110 that provide photographic prints for digital images. As illustrated in FIG. 1, the present invention generally comprises a system that utilizes the individual characteristics of a given output device such as a photographic printer to optimize the time between service visits to replenish consumables and to provide faster production by utilizing both printing devices when possible.

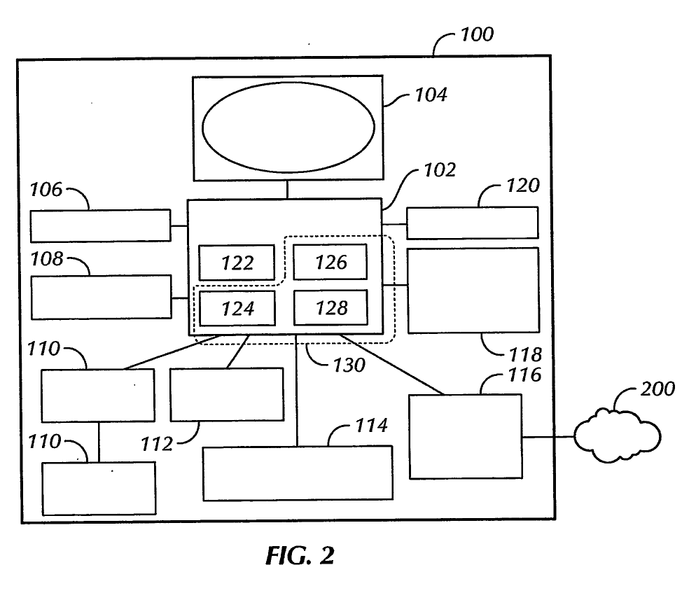

FIG. 2 is a block diagram of the exemplary digital photographic kiosk 100. The kiosk 100 may be located in a dedicated stand-alone cabinet, in a wall, in a cabinet with other devices, or in another housing or location. The particular physical embodiment of the kiosk 100, such as the size and shape of its cabinet, or the presence of a dedicated cabinet at all, is not critical to the invention. The kiosk 100 includes a system controller or information handling system 102 that controls the operation of the kiosk 100. The system controller 102 may be any computing device capable of executing instructions and handling the inputs and outputs necessary to the operation of the kiosk. For example, the system controller 102 may be an off-the-shelf personal computer that includes a motherboard and interface card slots. FIG. 2 shows some of the major functions of the system controller 102, which include, but are not limited to, a photo editing function 122 and a checkout function 130 which further comprises a photo printing function 124, a photo archiving function 126, and a payment function 128.

The system controller 102 also connects to a user interface 104 that presents information and enables the user to interact with the kiosk 100. The user interface 104 may include a cathode ray tube, a flat panel liquid crystal display, or any other device capable of displaying information to a customer, alone or in combination with a series of multifunction buttons whose current functions may be indicated on the display. Additionally, the system controller 102 connects to at least one input data reader 106. The input data reader 106 may be any device adapted to read digital data from a portable data storage device. The system controller 102 also connects to an internal storage device 108 such as a hard disk drive. The internal storage device 108 is adapted to store the photographic data received through the data reader 106 from a customer. The internal storage device 108 may also store other data, such as instructions for execution by the system controller 102.

The kiosk 100 further includes other components that connect to the system controller 102 that includes a payment acceptor 112 and a receipt/coupon printer 118. Also connected to the system controller 102 is a network interface 116 that provides a communications link 200 to one or more connections such as a wired or wireless local area network, wide area network, internet connection, telephone connection, or wireless device carried by a customer. The kiosk 100 further includes an output digital media storage device 114 connected to the system controller 102, which stores customers' information on standard digital media such as a DVD or CD-ROM disk. Finally, the system controller 102 connects to an input unit 120 that may be a keyboard, keypad, trackball, or other device or combination through which the customer can interact with the kiosk 100.

The digital photographic kiosk 100 typically contains one or more output print devices 110. The preferred embodiment of the output print devices of the present invention includes photographic printers such as dye sublimation printers or ink jet printers with each type of printer using different types of consumable media. The consumable media used by dye sublimation printers includes dye transfer ribbons, paper, and material for a protective overcoat laminate. The consumable media used by inkjet printers includes inkjet cartridges and paper. The output print devices 110 connect to the system controller 102, which controls the utilization of consumable media produced by the photographic printers 110.

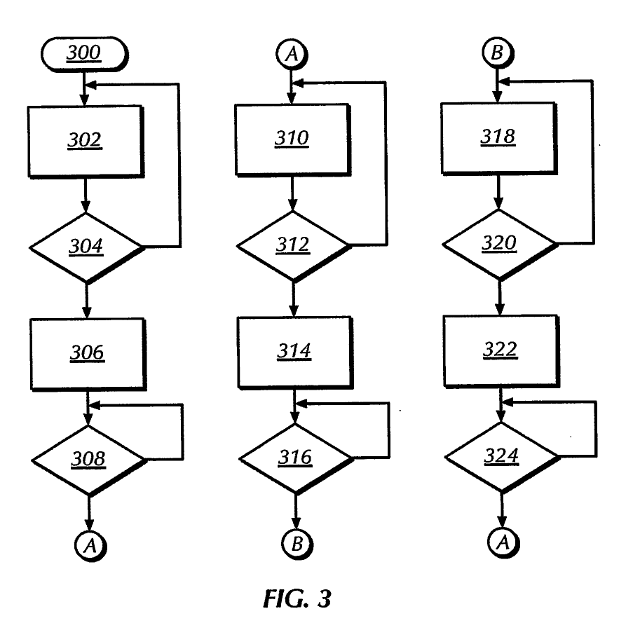

FIG. 3 is a flowchart of the preferred embodiment of the present invention. The general strategy of the present invention is to have two or more output devices 110 produce at a ratio to each other to maximize the production capabilities (i.e., output speed) when the devices have consumable media, and at the same time, to ensure that at least one output print device has sufficient consumable media to maintain the system operation of the kiosk 100 when the other output print device is exhausted of consumable media and awaiting service.

The initial assumption of the present invention 300 is to assume that the two output print devices 110 have the same storage capacity. When the kiosk starts to service print requests 302, the second output print device will produce a disproportionate amount of production compared to the first output print device. One skilled in the art will appreciate that there are a number of methodologies to have one printer produce more output relative to another printer so that the two printers are not alternating in producing output. The present invention encompasses all of these strategies for producing a disproportionate amount of product between the different output print devices. This disproportionate amount of production in favor of the second output print device proceeds until the first output print device has 2 to 1 ratio of remaining consumable media to the second output print device 304. This first preferred ratio is achieved when the amount of consumable media in the first output print device, minus the amount of consumable media in the second output print device, equals half of the amount of consumable media material available when each output print device is full.

Once the preferred 2 to 1 ratio of consumable media has been achieved between the output print devices, the system controller 102 will maintain this ratio of consumable media by alternating production of the output requests between the two output print devices 306. When both output print devices are producing print requests in an alternating fashion, the overall print time to produce output such as photographic prints from the kiosk 100 will be greatly enhanced due to the increased production speed. When the second output print device is exhausted of consumable media, the first output print device will produce all output requests until the second output print device has been replenished with consumable media 308 during a service or maintenance visit.

When the second output print device has been maintained and refilled with consumable media, the second output print device will produce output at a disproportionate amount 310 to the first output print device until a 2 to 1 ratio in consumable media between the output print devices is regained 312. At this point, the second output print device will now have twice the consumable media of the first output print device. This second preferred ratio is achieved when the amount of consumable media in the second output print device, minus the amount of consumable media in the first output print device, equals half of the amount of consumable material available when an individual device is full.

Once the preferred 2 to 1 ratio of consumable media has been achieved between the output print devices, the system controller 102 will maintain this ratio of consumable media by alternating production of the output requests between the two output print devices 314. When both output print devices are producing print requests in an alternating fashion, the overall print time to produce output such as photographic prints from the kiosk 100 will be greatly enhanced due to the increased production speed. When the first output print device is exhausted of consumable media, the second output print device will produce all output requests until the first output print device has been replenished with consumable media 316 during a service or maintenance visit.

When the first output print device has been maintained and refilled with consumable media, the first output print device will produce output at a disproportionate amount 318 to the second output print device until a 2 to 1 ratio in consumable media between the output print devices is regained 320. At this point, the first output print device will now have twice the consumable media of the second output print device. The first-preferred ratio is achieved when the amount of consumable media in the first output print device, minus the amount of consumable media in the second output print device, equals half of the amount of consumable material available when an individual device is full.

Once the preferred 2 to 1 ratio of consumable media has been achieved between the output print devices, the system controller 102 will maintain this ratio of consumable media by alternating production of the output requests between the two output print devices 322. When both output print devices are producing print requests in an alternating fashion, the overall print time to produce output such as photographic prints from the kiosk 100 will be greatly enhanced due to the increased production speed. When the second output print device is exhausted of consumable media, the first output print device will produce all output requests until the second output print device has been replenished with consumable media 324 during a service or maintenance visit.

The system controller 102 maintains continued production of output with consumable media in an alternating fashion as illustrated above.

Another embodiment of the present invention includes the use of 3 output print devices to satisfy the output requests. In this embodiment, the output print devices are grouped into 2 logical output print devices. That is, physical output print devices 1 and 2 would be logical output print device 1. And, physical output print device 3 be logical output print device 2. One skilled in the art will appreciate that the physical output print devices could have other logical groupings. With 2 logical output print devices, this embodiment of the present invention uses the above described methodology that optimizes the output speed of the kiosk and the replenishment of consumable media.

Another embodiment of the present invention includes the use of four output print devices to satisfy the output requests. In this embodiment, the output print devices are grouped into 2 logical output print devices. That is, physical output print devices 1 and 2 would be logical output print device 1. And, physical output print devices 3 and 4 would be logical output print device 2. One skilled in the art will appreciate that the physical output print devices could have other logical groupings. With 2 logical output print devices, this embodiment of the present invention uses the above described methodology that optimizes the output speed of the kiosk and the replenishment of consumable media.

To summarize, the present invention discloses a digital photographic kiosk that optimizes the output speed and the replenishment of consumable media. The kiosk includes a plurality of output print devices that use consumable media. A system controller in the kiosk controls the utilization of consumable media by the output print devices in a manner that both optimizes the production of output from the output print devices and optimizes the replenishment of the consumable media used by the output print devices.

The system controller initially causes a disproportionate amount of utilization of consumable media to be produced from the second output print device compared to the first output print device. The disproportionate amount of utilization of consumable media from the second output print device continues until the amount of consumable media of the first output print device is in a first preferred ratio compared to the amount of consumable media in the second output print device.

When the first preferred ratio is achieved between the consumable media of the first output print device and the second output print device, the system controller alternates the utilization of consumable media between the first output print device and the second output print device until the second output print device exhausts its consumable media. Upon replenishment of the consumable media of the second output print device, the system controller causes a disproportionate amount of utilization of consumable media to be produced from the second output print device compared to the first output print device. The disproportionate amount of utilization of consumable media continues until the amount of consumable media of the second output print device is in a second preferred ratio compared to the amount of consumable media in the first output print device.

When the second preferred ratio is achieved between the consumable media of the second output print device and the first output print device, the system controller alternates utilization of consumable media between the second output print device and the first output print device until the first output print device exhausts its consumable media. Upon replenishment of the consumable media of the first output print device, the system controller causes a disproportionate amount of utilization of consumable media to be produced from the first output print device compared to the second output print device. The disproportionate amount of utilization of consumable media continues until the amount of consumable media of the first output print device is in the first preferred ratio compared to the amount of consumable media in the second output print device.

When the first preferred ratio is achieved between the consumable media of the first output print device and the second output print device, the system controller alternates utilization of consumable media between the first output print device and the second output print device until the second output print device exhausts its consumable media. The system controller maintains continued utilization of consumable media in the above alternating process.

One embodiment of the present invention uses a first preferred ratio that occurs when the amount of consumable media of the first output print device minus the amount of consumable media of the second output print device equals half the amount of consumable media available when the first output print device and the second output print device are both full of consumable media. Additionally, a second preferred ratio occurs when the amount of consumable media of the second output print device minus the amount of consumable media of the first output print device equals half the amount of consumable media available when the second output print device and the first output print device are both full of consumable media.

One embodiment of the present invention includes the use of dye sublimation printers as the first and second output print devices with dye transfer ribbons, paper, and a protective overcoat laminate as the consumable media. And, another embodiment of the present invention includes the use of inkjet printers as the first and second output print devices with inkjet print cartridges and paper as the consumable media.

Other embodiments of the invention will be apparent to those skilled in the art after considering this specification or practicing the disclosed invention. The specification and examples above are exemplary only, with the true scope of the invention being indicated by the following claims.

Another embodiment of the present invention includes the first output print device comprising a first logical output print device and the second output print device comprising a second logical output print device. The first logical output print device further comprises one or more physical output print devices. And, the second logical output print device further comprises one or more physical output print devices.

The following invention is claimed:

1. An apparatus that optimizes the output speed and the replenishment of consumable media in a digital photographic kiosk, comprising:
a first output print device with consumable media;
a second output print device with consumable media;
a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

2. A system that optimizes the output speed and the replenishment of consumable media in a digital photographic kiosk, comprising:
a digital photographic kiosk that further comprises:
a first output print device with consumable media;
a second output print device with consumable media;
a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

3. A method to make a digital photographic kiosk that optimizes the output speed and the replenishment of consumable media, comprising:
providing a first output print device with consumable media;
providing a second output print device with consumable media;
providing a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

4. A method to use a digital photographic kiosk that optimizes the output speed and the replenishment of consumable media, comprising:
using consumable media with a first output print device;
using consumable media with a second output print device;
controlling the utilization of consumable media of said first output print device and said second output print device with a system controller;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

5. A program storage device readable by a computer that tangibly embodies a program of instructions executable by the computer to perform a method to use a digital photographic kiosk that optimizes the output speed and the replenishment of consumable media, comprising:
using consumable media with a first output print device;
using consumable media with a second output print device;
controlling the utilization of consumable media of said first output print device and said second output print device with a system controller;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

6. A dependent claim according to claims 1, 2, 3, 4, or 5 wherein said first preferred ratio occurs when the amount of consumable media of said first output print device minus the amount of consumable media of said second output print device equals half the amount of consumable media available when said first output print device and said second output print device are both full of consumable media.

7. A dependent claim according to claims 1, 2, 3, 4, or 5 wherein said second preferred ratio occurs when the amount of consumable media of said second output print device minus the amount of consumable media of said first output print device equals half the amount of consumable media available when said second output print device and said first output print device are both full of consumable media.

8. A dependent claim according to claims 1, 2, 3, 4, or 5 wherein said first output print device or said second output print device further comprises a dye sublimation printer and where the consumable media further comprises dye transfer ribbons, paper, and protective overcoat laminate.

9. A dependent claim according to claims 1, 2, 3, 4, or 5 wherein said first output print device or said second output print device further comprises an inkjet printer and where the consumable media further comprises inkjet print cartridges and paper.

10. A dependent claim according to claims 1, 2, 3, 4, or 5 wherein said first output print device further comprises a first logical output print device and said second output print device further comprises a second logical output print device, said first logical output print device further comprises one or more physical output print devices, and said second logical output print device further comprises one or more physical output print devices.

11. An apparatus that optimizes the output speed and the replenishment of consumable media in a digital photographic kiosk, comprising:
a first output print device with consumable media;
a second output print device with consumable media;
a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device, said first preferred ratio occurs when the amount of consumable media of said first output print device minus the amount of consumable media of said second output print device equals half the amount of consumable media available when said first output print device and said second output print device are both full of consumable media;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device, said second preferred ratio occurs when the amount of consumable media of said second output print device minus the amount of consumable media of said first output print device equals half the amount of consumable media available when said second output print device and said first output print device are both full of consumable media;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

12. A system that optimizes the output speed and the replenishment of consumable media in a digital photographic kiosk, comprising:
a digital photographic kiosk that further comprises:
a first output print device with consumable media;
a second output print device with consumable media;
a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device, said first preferred ratio occurs when the amount of consumable media of said first output print device minus the amount of consumable media of said second output print device equals half the amount of consumable media available when said first output print device and said second output print device are both full of consumable media;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device, said second preferred ratio occurs when the amount of consumable media of said second output print device minus the amount of consumable media of said first output print device equals half the amount of consumable media available when said second output print device and said first output print device are both full of consumable media;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

13. A method to make a digital photographic kiosk that optimizes the output speed and the replenishment of consumable media, comprising:
providing a first output print device with consumable media;
providing a second output print device with consumable media;
providing a system controller that controls the utilization of consumable media of said first output print device and said second output print device;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device, said first preferred ratio occurs when the amount of consumable media of said first output print device minus the amount of consumable media of said second output print device equals half the amount of consumable media available when said first output print device and said second output print device are both full of consumable media;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device, said second preferred ratio occurs when the amount of consumable media of said second output print device minus the amount of consumable media of said first output print device equals half the amount of consumable media available when said second output print device and said first output print device are both full of consumable media;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

14. A method to use a digital photographic kiosk that optimizes the output speed and the replenishment of consumable media, comprising:
using consumable media with a first output print device;
using consumable media with a second output print device;
controlling the utilization of consumable media of said first output print device and said second output print device with a system controller;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device, said first preferred ratio occurs when the amount of consumable media of said first output print device minus the amount of consumable media of said second output print device equals half the amount of consumable media available when said first output print device and said second output print device are both full of consumable media;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device, said second preferred ratio occurs when the amount of consumable media of said second output print device minus the amount of consumable media of said first output print device equals half the amount of consumable media available when said second output print device and said first output print device are both full of consumable media;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

15. A program storage device readable by a computer that tangibly embodies a program of instructions executable by the computer to perform a method to use a digital photographic kiosk that optimizes the output speed and the replenishment of consumable media, comprising:
using consumable media with a first output print device;
using consumable media with a second output print device;
controlling the utilization of consumable media of said first output print device and said second output print device with a system controller;
wherein said system controller initially causes a disproportionate amount of utilization of consumable media to be produced from said second output print device compared to said first output print device, the disproportionate amount of utilization of consumable media from said second output print device continues until the amount of consumable media of said first output print device is in a first preferred ratio compared to the amount of consumable media in said second output print device, said first preferred ratio occurs when the amount of consumable media of said first output print device minus the amount of consumable media of said second output print device equals half the amount of consumable media available when said first output print device and said second output print device are both full of consumable media;
when said first preferred ratio is achieved between the consumable media of said first output print device and said second output print device, said system controller alternates utilization of consumable media between said first output print device and said second output print device until said second output print device exhausts its consumable media;
upon replenishment of the consumable media of said second output print device, said system controller causes a disproportionate amount of utilization of consumable media to be produced from said second output print device compared to said first output print device, the disproportionate amount of utilization of consumable media continues until the amount of consumable media of said second output print device is in a second preferred ratio compared to the amount of consumable media in said first output print device, said second preferred ratio occurs when the amount of consumable media of said second output print device minus the amount of consumable media of said first output print device equals half the amount of consumable media available when said second output print device and said first output print device are both full of consumable media;
when said second preferred ratio is achieved between the consumable media of said second output print device and said first output print device, said system controller alternates utilization of consumable media between said second output print device and said first output print device until said first output print device exhausts its consumable media;
upon replenishment of the consumable media of said first output print device, said system controller causes a disproportionate amount of utilization of consumable media to be produced from said first output print device compared to said second output print device, the disproportionate amount of utilization of consumable media continues until the amount of consumable media of said first output print device is in said first preferred ratio compared to the amount of consumable media in said second output print device;
when said first preferred ratio is achieved between the consumable media of said first output print device and said second output print device, said system controller alternates utilization of consumable media between said first output print device and said second output print device until said second output print device exhausts its consumable media; and
said system controller maintains continued utilization of consumable media in the above alternating process.

16. A dependent claim according to claims 11, 12, 13, 14, or 15 wherein said first output print device or said second output print device further comprises a dye sublimation printer and where the consumable media further comprises dye transfer ribbons, paper, and protective overcoat laminate.

17. A dependent claim according to claims 11, 12, 13, 14, or 15 wherein said first output print device or said second output print device further comprises an inkjet printer and where the consumable media further comprises inkjet print cartridges and paper.

18. A dependent claim according to claims 11, 12, 13, 14, or 15 wherein said first output print device further comprises a first logical output print device and said second output print device further comprises a second logical output print device, said first logical output print device further comprises one or more physical output print devices, and said second logical output print device further comprises one or more physical output print devices.
